(19) United States
(12) Patent Application Publication
(10) Pub. No.: US 2023/0047883 A1
(43) Pub. Date: Feb. 16, 2023

(54) FLEXIBLE PUNCH AND WELD SYSTEM

(71) Applicant: Magna Exteriors Inc., Concord (CA)

(72) Inventor: Hideki Yamamoto, Plymouth, MI (US)

(73) Assignee: Magna Exteriors Inc., Concord, ON (CA)

(21) Appl. No.: 17/797,251

(22) PCT Filed: Feb. 4, 2021
(86) PCT No.: PCT/US2021/016608

§ 371 Date: Aug. 3, 2022

Related U.S. Application Data
(60) Provisional application No. 62/970,008, filed on Feb. 4, 2020.

(51) Int. Cl. B23Q 15/22; B23Q 7/04

(52) U.S. Cl. CPC B23Q 15/22; B23Q 7/046; B23Q 2717/00

(57) ABSTRACT

A flexible assembling system incorporating at least one manufacturing cell including at least one universal fixture, at least one position monitoring device (e,g., monitoring system, 3D vision system, 3D vision system/scanner, artificial intelligence position determination and monitoring, artificial intelligence vision system to locate part or a feature(s) of the part, and combinations thereof), and at least one programmable robot or machine (e.g., punch, weld, etc.). The at least one universal fixture is a non-dedicated fixture such that the fixture is usable with various products and not dedicated to only one specific part being manufactured.

### CROSS-REFERENCE TO RELATED APPLICATIONS

This application is a POT International Patent Application claiming priority to U.S. Provisional Application No. 62/970,008, filed Feb. 4, 2020. The disclosure of the above application is incorporated herein by reference.

### FIELD OF THE INVENTION

The present invention relates to a flexible manufacturing system incorporating a fixturing assembly adapted for vehicle parts and method of manufacturing vehicle parts.

### BACKGROUND OF THE INVENTION

In the past, fixturing assemblies for flexible parts have been customized for each part and application, which is expensive, rigid and requires dedicated fixtures and machines to produce each product.

A known flex cell has a CNC cut nest position defined by nesting and robot points, 2 and 3 loading stations have a shared robot on an access rale, and welding operations. 2 or 3 different products can be produced at one time; otherwise, nest changeover will be required.

Another known cell has a multi-station dial such as 3 stations dial system, and each has an assigned task (more stations can be added for increased volume). Such as 3 stations where the first station loads/unloads, 2^{nd} punches the part and the 3^{rd} sonic welds the part. This disadvantageously requires product specific tooling and other program specific requirements (e.g., OEM requirements) such as particular castle horns, welding tip needles, end effectors, end of arm tooling, etc. The system may allow flexibility because of tool and nest changeover; however, the unused product robot needs to be swapped for other products and the welding tip or other parts may also need to be changed. The system may allow process repeatability, depending on the part position, but requires a CNC cut nest. Cycle time will increase with the number of stations required. This known system may have a shorter cycle time but take up more floor space.

Another known flex cell has a 5-station dial, clip installation, and sonic welding. It may be able to accommodate different products, but it still necessitates dedicated nesting. The system may allow flexibility because of tool and nest changeover; however, it still requires dedicated nesting. The system may allow process repeatability, but requires a CNC cut nest.

Another known cell is a single cell; start to finish, with a combination of tooling. This has disadvantageously slow cycle time, which requires more cells to increase cycle time. A first station is for load/unload of part. 2^{nd} is a machining center (punch and weld). The system may allow flexibility because of tool and nest changeover; however, it still requires dedicated nesting. The system may allow process repeatability, but requires a CNC cut nest. The nested part is held, and a machine or robot application is incorporated but is “flying in blind” and only a sensor (e.g., part position sensor) “sees” the part and starts processing steps. A similar known cell has a 2^{nd} machining center to punch and locate a bracket(s), with similar disadvantageous. Both of these known systems may take up less floor space, depending on volume, but have longer cycle times.

Punch and welding commonly uses CNC cut nests to support parts. With traditional machines, parts are presented on the CNC cut nest, and punch and welding features are set to process position. In traditional robotics, parts are presented on the CNC cut nest; the robot will bring the punching/welding tool to the fascia part based on predetermined points or take the entire CNC nesting with parts to a machining center based on predetermined points.

Machines/robotic set ups are relying on CNC cut nests and nest loading repeatability to achieve quality requirements. All flexible punch and welding set up gained flexibility by CNC tooling nest changeovers.

With all of the aforementioned, part position repeatability is reliant on CNC cut nests. Flexibility is only gained by tool/nest changeover. All of which requires more space for storage, time, expense in tooling and other disadvantages.

Accordingly, there exists a need for a production cell system incorporating intelligent locating and positioning at predetermined production-capable speeds combined with flexible nesting for a part (e.g., flexible fixturing, and/or tooling reduction, and/or utilize highly flexible tooling) and method for manufacturing a part using same.

In addition, as to hole creation, known mechanical punches have no tool flexibility and requires moderate nesting. Known lasers cannot round corners, do leave burn marks, and have high maintenance. Known routers do not accommodate round corners, have a slow processing time, and high nest requirement. Double sided PSA tape has a moderate nest requirement. As to bracket holding, sonic welding has moderate flexibility and processing time, and high nest requirement. Adhesive has no tool flexibility, slow processing time, moderate nest requirement, low reliability, and high maintenance.

Furthermore, conventionally, punch and welding of exterior components requires dedicated machines part design. When production is over, they are commonly replaced with new machines to support another program. In addition, when one assembly area supports multiple programs, the number of machines on the floor increases. Also, those machines need to be maintained for service supply parts after production life ends.

Accordingly, there is a desire to incorporate flexible punch and welding in the system which can support both high speed production and high cycle time service with less dedicated tooling.

### SUMMARY OF THE INVENTION

The present invention is directed to a production system incorporating a fixturing assembly for vehicle parts and method of making vehicle parts. According to an aspect of the present invention, a production cell system incorporates intelligent locating and positioning and flexible nesting for at least one part and method for manufacturing parts. In accordance with aspects of the present invention there is provided a thin wall capable flexible assembly cell and fixturing that reduces the costs for assets.

According to aspects of the present invention, there is provided a flexible production assembling system incorporating at least one part fixture for a plurality of different parts, at least one position monitoring device (e.g., monitoring system, 3D vision system, 3D vision system/scanner, artificial intelligence position determination and monitoring, AI to locate part or a feature(s) of the part), and at least one programmable robot or machine (e.g., punch, weld, etc.). Preferably, the at least one part fixture is a non-dedicated fixture such that the fixture is used with various products.

Challenges/Considerations optimized according to aspects of the present invention include: Part picking system selection and artificial intelligence programing; Assembly method type and flex fixturing harmonization; Meeting the Overall Equipment Effectiveness (OEE) target; Material logistics and handling of components and finished product; New maintenance planning and training; Division skillset development and skilled resource acquisition; Optimize the capital costs and balance the line, etc.

The present invention provides common large component nesting (simple support), reduced tooling changeover, reduced tooling. One setup can support multiple vehicle programs with minimal changeover steps, in accordance with the present invention. The present invention is also compatible with and optimizes both mass production and high cycle time service part production (e.g., aftermarket service parts).

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a part fixture with 2-arm support;

FIG. 2 is a perspective view of an adjustable pad support:

FIG. 3 is a perspective view of the adjustable pad support of FIG. 3 supporting a vehicle part;

FIG. 4 is a perspective view of an adjustable pad support;

FIG. 5 is a perspective view of a prior art CNC nest support;

FIG. 6 is a perspective view of an exemplary part fixture with 2-bar support, in accordance with aspects of the present invention;

FIG. 7 is an illustration of an exemplary production cell, in accordance with the present invention; and

FIG. 8 is an illustration of an exemplary production system with a plurality of automated stations, in accordance with the present invention.

### DETAILED DESCRIPTION OF THE PREFERRED EMBODIMENTS

The following description of the preferred embodiment(s) is merely exemplary in nature and is in no way intended to limit the invention, its application, or uses.

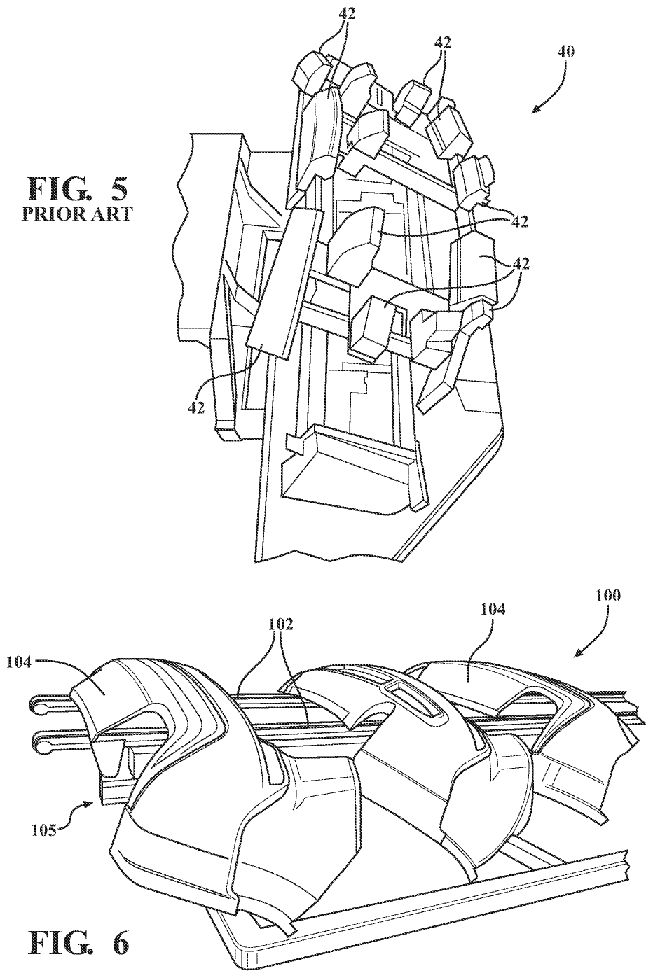

Referring to FIGS. 6-8 generally, in accordance with the present invention there is depicted a flexible assembling system and method for manufacturing vehicle parts. According to the aspect of the present invention, the flexible assembling system incorporates at least one part fixture compatible with a variety of different products (e.g., different large parts of various shapes), at least one part position monitoring device, e.g., vision system, at least one programmable robot or machine, and at least one tool, e.g., punching and/or welding tool). The vision system finds the position of the part. A determination of the correct positioning of the part to be processed and a final positioning determination is preferred. Most preferably, the flexible system forms at least one manufacturing cell for processing parts. At least one part, e.g., vehicle part, fascia, rear fascia, front fascia, rocker panel, panel, etc. or any other part. The part material is at least one predetermined material, e.g., plastic material, composite material, SMC, etc. or any other material. Preferably the at least one part fixture is a non-dedicated fixture. In accordance with aspects of the present invention, an advancing device, e.g., cart, simplified cart, conveyor, turn table, rail, carrier, etc. or combinations thereof are operably incorporated in the flexible system to move the at least one part fixture to predetermined cells.

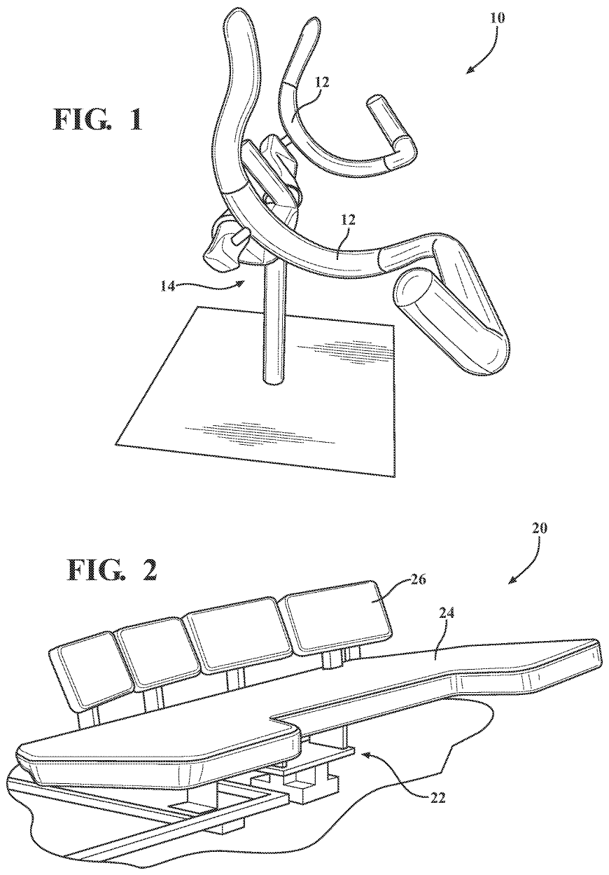

Referring to FIGS. 1 to 5, there is illustrated various nesting configurations from less (FIG. 1) to more complex. FIG. 1 illustrates a light-duty fixture indicated generally at 10 that is a 2-arm support fixture (e.g., “reindeer” fixture) to hold at least one part at a time (e.g., useable to at least stage and install park systems, etc.), or usable throughout the manufacturing system, e.g., inspection area, etc. The part is supported by at least one arm 12, preferably at least two arms 12,12. Each support arm 12 is connected to a base shown generally at 14, preferably that is adaptable to operably advance (e.g., roll, travel on a belt, etc.). The 2-arm support fixture 10 has relatively high use flexibility (e.g., used for more than one vehicle part/vehicle models/platforms) and requires relatively less tooling (much less than CNC, for example), but has relatively low position placement repeatability. The 2-arm support fixture 10 is relatively simplistic when compared to FIGS. 2-5.

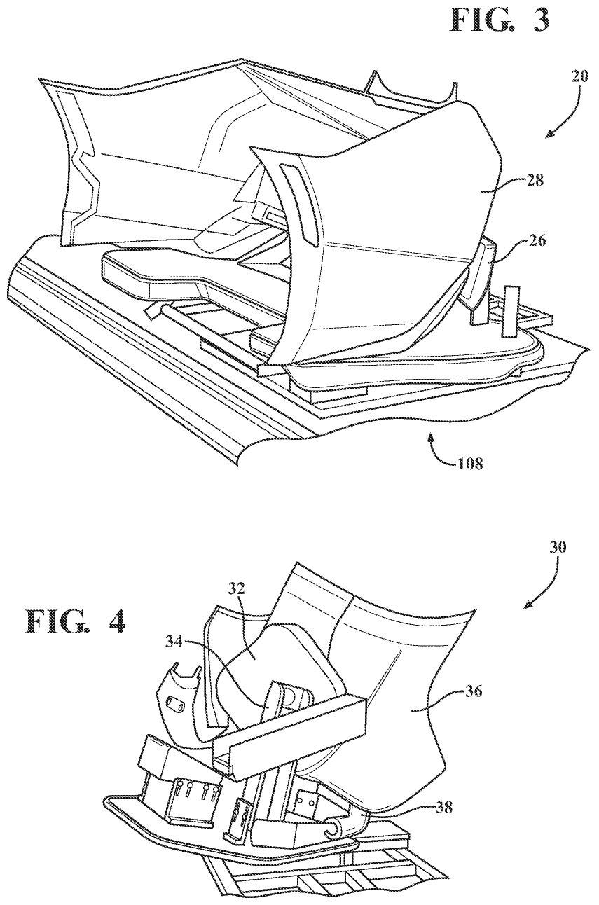

FIGS. 2 to 3 illustrate a medium-duty fixture indicated generally at 20 that is an adjustable pad fixture to hold at least one part at a time (e.g., for vehicle part general assembly) using at least one adjustable pad support 24. This provides predetermined localized support with padding or another predetermined feature. Each pad support 24 is operably connected to a base shown generally at 22, preferably adaptable to operably advance (e.g., roll, travel on a belt, carried on an advancing system indicated generally at 108, etc.). FIG. 2 illustrates a lower pad support 24 and an upper pad support 26. At least one part 28 is supported by the pad supports 24,26. This fixture 20 has less flexibility and more tooling or complexity than the 2-arm fixture 10 but more position placement repeatability.

FIG. 4 illustrates a medium-duty fixture indicated generally at 30 that is an adjustable pad fixture to hold at least one part at a time (e.g., for vehicle part general assembly) using at least one adjustable pad support 32 (preferably at least two 32,38, where at least one is an upper and at least one is a lower) connected to a base 34, preferably adaptable to operably advance (e.g., roll, travel on a belt, etc.). The pad support(s) 32,38 hold the part 36. This provides predetermined localized support with padding or another predetermined feature.

FIG. 5 illustrates a heavy-duty fixture shown generally at 40 to hold at least one part at a time (e.g., to install grill snaps, etc.) and that is a CNC nest support. The CNC nest support 40 has a plurality of supports 42 to hold the part. This is traditional machine milled nesting that accommodates only one product. There is no flexibility. CNC tooling is also expensive. CNC nest support 40 provides high position reputability.

Moving now to FIG. 6, there is illustrate an exemplary fixture including at least one support for supporting at least one part, which fixture has the highest flexibility and least tooling but less position reputability, relative to FIGS. 1-5. FIG. 6 depicts an exemplary flexible part fixture, shown generally at 100, in accordance with aspects of the present invention. The flexible part fixture 100 is a predetermined shape and configuration depending on the particular applications. Preferably, the flexible part fixture 100 incorporates a 2-bar support and can support any of a plurality of predetermined products (e.g., fascia, grills, bumpers, etc. various models/vehicle platforms, a plurality of part shapes, etc.). In a preferred aspect of the present invention, at least two bars 102,102 are provided for holding at least one part 104 and can support any other predetermined products (e.g., front fascia, rear fascia, rocker panels, panels, etc.). Each support bar 102 is operably connected to a base 105 or cart (separate care or incorporated as the base) preferably adapted to operably advance (e.g., roll, slide, travel on a belt, etc.). In accordance with the present invention, the at least one flexible part fixture 100 is a non-nesting fixture, not CNC cut, not machined nesting, not water-jet cut, and not a machine-made/formed nest. Rather, the flexible part fixture is light duty or basic/simple fixturing for selectively holding at least one part at a time (minimized tooling), and preferably accommodates a plurality of predetermined different vehicle products, such as, by way of non-limiting example, a sedan fascia, a pickup truck fascia, and an SUV rocker panel. The flexible part fixture 100 provides the highest flexibility, requires the least tooling (or no tooling). It may also provide the least position repeatability; however, part positioning monitoring and placement is enhanced in accordance with aspects of the present invention, as will be described in greater detail below.

The base 105 is preferably operable to be conveyed, e.g., manually moved or on a conveyance system in production of vehicle parts or any predetermined advancing system, in accordance with aspects of the present invention. The base 105 is operably shaped to be advanced in a substantially automated process. Alternatively, casters, e.g., urethane casters, are operably connected to the base 105 or a cart portion to move the support holding the part in production, when/if needed.

It is understood that the flexible part fixture 100 is operably adaptable for any at least one predetermined part, e.g., automotive vehicle parts. Preferably, the fixture 100 is adaptable for incorporating in the manufacturing of a plurality of parts. By way of non-limiting example, useable in the production of predetermined panels and the same fixture is useable in the production of predetermined fascia, or any other predetermined part(s).

It is understood that the fixture 100, including the support bars 102, etc., are operably adaptable depending on the particular applications as suitable and necessary nesting support where needed depending on the shape of the parts without departure from the scope of the present invention.

With known systems, a nested part is held, and a machine or robot application moves in “blind”. Only a small sensor is used, at times, such as a part sensor that “sees” the part and then the process is started.

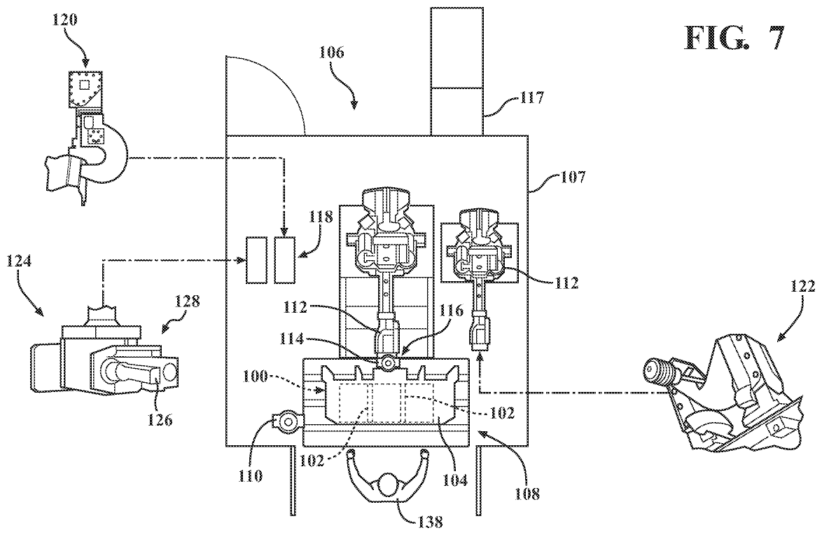

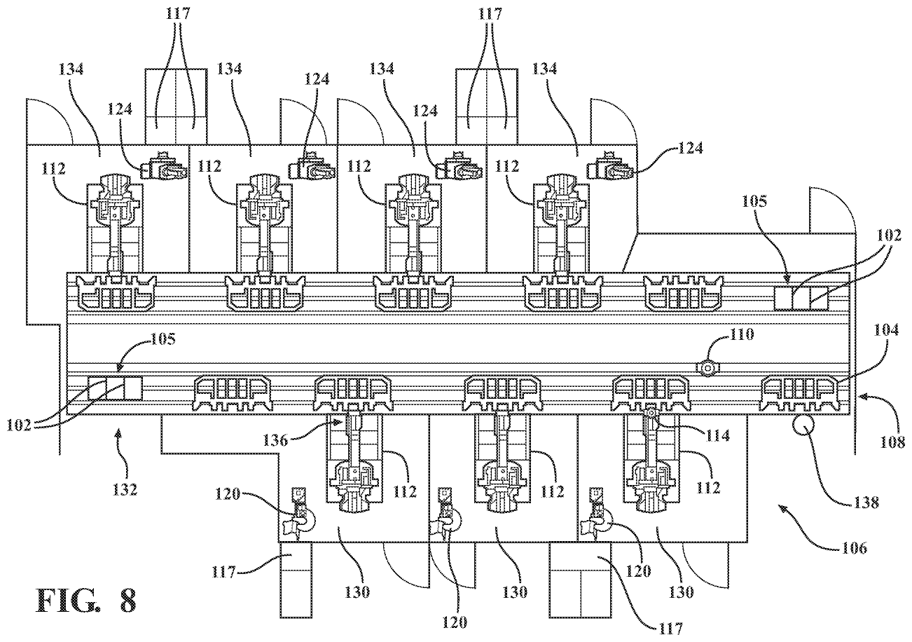

Referring now to FIGS. 7-8 generally, in accordance with aspects of the present invention, there is provided: (1) Non-CNC cut nest(s), which each can accept multiple large parts (nest(s) are operably attachable to an advancing system for faster production to present WIP (work-in-process) to the next cell which is assigned to a different location for punching / welding processes); (2) Part position sensing device(s); (3) Robot(s); (4) Changeable punching and welding tool(s).

According to aspects of the present invention, by utilizing part position sensing technologies (such as vision system(s), lidar(s), laser(s), scanner(s), 3D vision, 3D scanner(s), etc., and any combinations thereof) in combination with artificial intelligence, achieving punch, weld, and quality requirements with non-CNC cut nests is made possible. The non-CNC cut nests accepts a plurality of different shapes of products and processes punch and weld (or other predetermined processes) on the same setup or with minimum changeover.

Referring to the FIGS. 7-8 generally, according to aspects of the present invention, there is provided a 1-layer or 2-layer system (or more) incorporating at least one artificial intelligence device (e.g,, three-dimensional (3D) vision, laser, 3D scanning, any suitable position technology, etc. and any combinations thereof) combined with at least one cell (e.g., robotic cell). In accordance with a preferred aspect of the present invention, there is provided a 1-layer artificial intelligence (AI) system. According to another aspect of the present invention there is provided a 2-layer artificial intelligence system. By way of example, at least one AI looking from a big view so that at least one robot moves into location (or alternatively, the part is operably moved further into location) and the robot hand (or other robotic or machine mechanism) incorporates an AI for positioning relative to the part, and the part located for punching at least one aperture, bracketing, welding or otherwise processing the part (e.g., utilizing one or more robots and predetermined tooling). Predetermined processing includes, but is not limited to, punching, bracketing, aperture creation, part insertion, clip install, sensor install, various park sensor installs, park sensor hole punch, welding or otherwise processing the part.

Referring to FIGS. 6-8 generally, and more particularly to FIG. 7, there is depicted a flexible assembling system shown generally at 106, in accordance with the present invention, adapted for at least one production cell indicated at box 107 that is a self-serving cell without having to have cells for different products. Each production cell is operably adaptable for accommodating a plurality of predetermined products of various shapes depending on the application, which significantly saves on production space, storage space, tooling costs, changeover (if any), and production downtime.

The flexible assembling system 106 includes at least one flexible part fixture 100 (“fixture”) that holds at least one part 104 (e.g., a 2-bar support bar fixture of FIG. 6 or any suitable scaled-down fixture shape and configuration with part flexibility and low tooling requirements that is not CNC cut). It is understood that, by way of non-limiting example, the flexible fixture may be a contoured 1 or 2-arm support, e.g., such as the reindeer support arms 12 of FIG. 1, without departure from the scope of the present invention. Preferably, the at least one-part fixture 100 is located on at least one conveying device indicated generally at 108 (e.g., cart, simplified fascia cart, cart with casters, rollers or wheels, belt, conveyor system, or any other device or arrangement suitable for selectively advancing the fixture 100 as needed). An operator 138 is depicted adjacent the part fixture 100 (e.g., for loading and/or unloading the part 104 into the cell 107; part load/unload station), however, it is understood that alternatively this step is automated.

The flexible assembling system 106 includes at least one first part position sensing device 110 (e.g., first vision system) incorporating artificial intelligence (AI), operable to give the overall view or “big picture” of the at least one part 104 on each fixture 100 (e.g., an overall fascia position monitor vision system).

The flexible assembling system 106 includes at least one robot 112. At least one second part position sensing device 114 (e.g., second vision system) is also provided incorporating AI, preferably as an AI vision system on the at least one robot 112 (e.g,, on a grab hand) and/or adjacent thereto (e.g., final positioning vision system on at least one predetermined location on or adjacent to the robot). The at least one robot 112 is preferably rotatable between at least two stations (e.g., load/unload and punch and/or weld). At least one programable controller 117 is provided for controlling the motion and operations of the at least one robot 112.

The at least one robot 112 preferably is one or more part-holding robots with a flex hand indicated generally at 116 (e.g., fascia holding robot with a flex hand). The at least one vision system 114 is preferably operably coupled toward the flex hand 116.

Alternatively, or additionally, the at least one robot 112 includes one or more robots with a clamp system indicated generally at 122, e.g., bean bag clamps with vacuum where parts 104 are grabbed, and vacuum applied inside for additional holding in a reasonable predetermined location.

The flexible assembling system 106 includes at least one processing station indicated generally at 118 (“station”). Preferably, the station 118 is a punch and weld tool station. Preferably, the station 118 includes at least one punch and die device shown generally at 120, more preferably, a C-frame punch and die device 120. Preferably, also included at the station 118 is at least one sonic weld device shown generally at 124, preferably, including at least one sonic weld horn 126 and at least one bracket holding jig indicated generally at 128. In accordance with preferred aspects of the present invention, at least one bracket is welded to the part 104. It is understood that any predetermined alternative welding, parts welded to the part 104, or any alternative processing is contemplated depending on the application without departure from the scope of the present invention. Processing includes, but is not limited to, e.g., punching, bracketing, aperture creation, part insertion, clip install, sensor install, various park sensor installs, park sensor hole punch, welding or otherwise processing the part.

Predetermined single or combination of function stations are contemplated depending on the application. It is understood that while punch and weld tools are described, it is contemplated that additional or alternative devices are used depending on the particular applications without departure from the scope of the present invention. While a sonic weld is described, it is understood that alternative welding, e.g., Infrared, vibration, etc., compatible devices are contemplated depending on the particular applications without departure from the scope of the present invention.

Preferably, the part position sensing devices 110,114 are artificial intelligence vision systems to locate the part 104 or at least one predetermined feature of the part (e.g., for robot 112 pick-up, predetermined processing, etc.). By way of non-limiting example, to locate a cutout feature on the part (e.g., for an exhaust hole) as the validating fixturing position. By way of another non-limiting example, locating scribe lines. By way of another non-limiting example, locating using scribe lines, scribe line height, or predetermined features unique in the part to scan position to locate the work area (e.g., such as at least one bracket or at least one bracket attachment area), or to scan the entire product and the AI will know where the at least one bracket goes.

At least one production cell 107 is provided. Preferably, at least a dual cell in parallel for higher volume is employed depending on the application without departure from the scope of the present invention. It is understood that the flexible assembling system 106 is adaptable depending on the application for increased part volumes with a plurality of robots 112 and stations 118.

Referring to the FIGS. 6-8 generally, and more particularly to FIG. 8 (wherein like numbers indicate like parts described in greater detail previously and incorporated herein), there is depicted the flexible assembling system shown generally at 106 incorporating a plurality of processing cells 130 and 134, each cell including at least one robot 112, in accordance with aspects of the present invention. FIG. 8 illustrates an exemplary production line overview incorporating at least one advancing system 108 (e.g., at least on conveyor) to advance a plurality of the flexible part fixtures 100 from cell to cell. While a substantially parallel advancing system 108 is depicted, it is understood that any configuration is contemplated depending on the application without departure from the scope of the present invention. The advancing system 108 is most preferably a conveyor belt on which the base 105 or cart of each flexible part fixture 100 is placed. The operator 138 loads at least one part 104, preferably a plurality of parts, on the at least one support bar 102 of each flexible part fixture 100 (preferably, onto a 2-bar support 102,102) (for clarity of other features in the drawing, some of the bars 102/fixtures 100 are omitted under the parts 104). Alternatively, loading the part on the fixture 100 is automated.

A plurality of first cells 130 are provided for performing a predetermined process, preferably, punching. At least one robot 112 in each cell (as further described above and shown in FIG. 7) operably grasps the part 104 for punching at least one aperture in a predetermined location. At least one first part position sensing device 110 incorporating artificial intelligence (AI), as explained in greater detail above and shown in FIG. 7, and at least one second part position sensing device 114 incorporating artificial intelligence (AI), as explained in greater detail above and shown in FIG. 7, is provided in each cell 130 (for clarity of other features in the drawing, some of the part position sensing devices 110,114 are omitted in some of the cells 130,134. It is understood that a vision system incorporating AI is used in combination with the respective robot 112 in each cell, as also explained in greater detail above). Preferably, at least one punch and die device 120, more preferably, a C-frame punch and die device 120, is provided in each cell 130 to process the part 104. Each cell 130 performs a predetermined process at predetermined locations on the part 104, which may be the same or different predetermined locations. It is understood that more or less than three cells 130 is contemplated without departure from the scope of the present invention. At least one area for removing any defective parts is preferably provided, as indicated generally at 132.

A plurality of second cells 134 are provided for performing a predetermined process, preferably, welding, most preferably, sonic welding. At least one robot 112 in each cell (as further described above and shown in FIG. 7) operably grasps the part 104 for punching at least one aperture in a predetermined location. At least one first part position sensing device 110 incorporating artificial intelligence (AI), as explained in greater detail above and also shown in FIG. 7, and at least one second part position sensing device 114 incorporating artificial intelligence (AI), as explained in greater detail above and also shown in FIG. 7, is provided in each cell 134 (for clarity of other features in the drawing, some of the part position sensing devices 110,114 are omitted. It is understood that each part position sensing device incorporating AI is used in combination with the respective robot 112 in each cell 134, as also explained in greater detail above. Preferably, at least one sonic weld device 124 is provided in each cell 134 to process the part 104. Each cell 134 performs a predetermined process at predetermined locations on the part 104, which may be the same or different predetermined locations. It is understood that more or less than four cells 134 are contemplated without departure from the scope of the present invention. The number and configuration of stations 130 and 134 are operably adaptable depending on space, the required predetermined processes, and production demand.

By utilizing robots 112 at each cell combined with part position sensing systems 110,114 (such as vision system(s), lidar(s), laser(s), scanner(s), 3D vision, 3D scanner(s), etc., and any combinations thereof) that incorporate artificial intelligence, achieving punch, weld, and quality requirements with non-CNC cut nests (e.g., flexible part fixtures 100) is made possible. The non-CNC cut nests accepts a plurality of different shapes of products and processes punch and weld (or other predetermined processes) on the same production volume setup or with minimum changeover.

A plurality of flexible part fixtures (or “nests”) 100 (e.g., multiple carts with nests) are traveling through automated stations, in accordance with aspects of the present invention. The number and types of stations will vary by the required process and production demand.

While a fascia is described, it is understood that the system 106 is adaptable for any predetermined parts, most preferably, but not exclusively, large parts for vehicles. It is further understood that the orientation of the parts depicted in the drawings is not intended to be limiting. Any predetermined orientation(s) is/are contemplated depending on the application without departure from the scope of the present invention.

Referring to FIGS. 6-8 generally, according to an aspect of the present invention the flexible assembling system 106 incorporates at least one of the following and any combinations thereof: at least one robot cell 107,130,134 having space with punch and/or sonic dock; at least one flexible part fixture 100 (e.g., fascia nest) that is non-CNC, laser or any other machine made nest; at least one 3D vision system/scanner to find process positions (e.g., 1-layer AI or 2-layer AI or at least two layers AI); at least one punch tool, e.g., on C-flame or any other suitable device); at least one sonic weld tool (e.g., on C-flame with centering clamp or any other suitable device), and at least one sonic generation.

Referring to FIGS. 6-8 generally, a significant advantage of the present invention is less complex and expensive fixturing that allows for use with various products. Another advantage of the present invention is machines that are not solely dedicated to a particular product (e.g., for punch). Predetermined program specific castle horns, needles, welding tip, etc. can be operably changed out (e.g., even automated) rather than requiring dedicated robots/machinery where the entire dedicated unused robot/machine sits idle and needs to be swapped out and put into use for other products (e.g., swapped for manufacturing other products where may just need to change welding tip). In accordance with an aspect of the present invention, a plurality of different welding tips is pre-loaded so do not need to change out welding tips or robots as was previously required by conventional systems.

In accordance with aspects of the present invention, the system is operable to achieve production capable speeds (e.g., advancing parts to process-dictated stations), provides flexible fixturing and tooling reduction (e.g., utilizing a highly flexible tooling with various different shaped parts), allows process position repeatability and necessary flexible nesting support as needed (e.g., part position locating processed by a robot). There is achievable program-specific tooling reduction; rather, the present invention provides a common nest (e.g., such as a reindeer fixture, 2-bar support, etc.), in accordance with aspects of the present invention. Preferably, a 3D vision system/scanner on the robot to process a current part location. Preferably, a flexible holding robotic hand for a plurality of different shaped parts is utilized. For punch and weld processing, by way of non-limiting example, program-specific punch tooling is used, and localized support pads are operably connected to the robot, in accordance with aspects of the present invention. For welding, generic sonic horns on the weld tooling and support pads on the robot are used, in accordance with aspects with the present invention. According to an aspect of the present invention, a robot clamp system is operable to locate at least one bracket to the predetermined correct location(s) on the part (e.g., a self-centering clamp).

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A flexible assembling system, comprising:
at least one part fixture adapted to operably support a plurality of predetermined parts;
at least one tool adapted to selectively perform at least one predetermined process on each of said plurality of predetermined parts;
at least one position monitoring system adapted to selectively locate the position of each of said plurality of predetermined parts, and/or the position of predetermined features of each of said plurality of predetermined parts, supported on said at least one part fixture; and
at least one robot adapted to process said location and selectively operably retrieve and hold each of said plurality of predetermined parts during tool processing, said at least one robot being programable to selectively process any shaped plurality of predetermined parts.

2. The flexible assembling system of claim 1, wherein the at least one part fixture is not CNC made, laser made or machined.

3. The flexible assembling system of claim 1, wherein the at least one part fixture is adapted for variously shaped predetermined products and is not limited to a single product.

4. The flexible assembling system of claim 1, wherein the at least one part fixture includes at least one universal support adapted for a plurality of vehicle products.

5. The flexible assembling system of claim 1, wherein the at least one tool is a punching or welding tool, wherein said at least one tool is changeable in said flexible assembling system.

6. The flexible assembling system of claim 1, wherein said at least one tool is a C-flame punch and die tool.

7. The flexible assembling system of claim 1, wherein said at least one tool is a sonic weld tool.

8. The flexible assembling system of claim 1, wherein said at least one robot includes a flex hand adapted to hold each of said plurality of predetermined parts.

9. The flexible assembling system of claim 1, wherein said at least one robot includes at least one clamp system including at least one bean bag clamp with vacuum applied adapted for additional holding of each of said plurality of predetermined parts in a predetermined location.

10. The flexible assembling system of claim 1, wherein said at least one position monitoring system includes at least one first monitoring device adapted to selectively provide an overall view on the location of each of said plurality of predetermined parts.

11. The flexible assembling system of claim 10, wherein said at least one position monitoring system further includes at least one second monitoring device operably attached to said at least one robot adapted to selectively provide a final location and positioning of said at least one robot relative to said part.

12. The flexible assembling system of claim 1, wherein said at least one position monitoring system incorporates artificial intelligence in combination with said at least one robot, wherein said at least one position monitoring system is selected from the group consisting of vision systems lidars, lasers, scanners, three dimensional vision, three dimensional scanners, and any combinations thereof.

13. The flexible assembling system of claim 1, wherein said at least one position monitoring system includes at least one first monitoring device that includes a three dimensional vision system adapted to selectively provide an overall view of the location of each of said plurality of parts supported on each of said plurality of at least one part fixture, and at least one second monitoring device that includes a scanner operably attached to each respective robot adapted to selectively provide a final determination of location of each respective part as well as part processing position for said at least one tool to perform said at least one predetermined process on the part.

14. The flexible assembling system of claim 1, wherein the at least one part fixture is operably coupled to a moveable base cart operable to convey said at least one part fixture through at least one station.

15. The flexible assembling system of claim 1, wherein the flexible assembling system operably incorporates a production line with a plurality of automated stations, each of said plurality of automated stations including a respective one of: said at least one robot; said at least one tool; said at least one part position monitoring system; and said at least one part fixture, wherein said plurality of predetermined parts are selectively operably advanced through said plurality of automated stations.

16. The flexible assembling system of claim 15, further comprising at least one advancing system adapted to operably move each of said at least one part fixtures supporting said plurality of predetermined parts, respectively, through said plurality of automated stations at at least one predetermined speed depending at least on predetermined processing requirements at each of said plurality of automated stations and a production volume demand.

17. The flexible assembling system of claim 1, wherein said at least one predetermined process is selected from the group consisting of punching, bracketing, aperture creation, part insertion, clip install, sensor install, park sensor install, park sensor hole punch, welding, and combinations thereof.

18. The flexible assembling system of claim 1, wherein said plurality of predetermined parts are vehicle parts selected from the group consisting of rear fascia, front fascia, rocker panel, front rocker panel, panel, bumper, and combinations thereof.

19. A flexible assembling system adapted for vehicle parts, comprising:
at least one part fixture with universal support adapted for selectively holding a plurality of different shaped parts;
at least one punch and weld station, comprising at least one punch tooling and at least one sonic weld tooling, wherein said at least one punch tooling and at least one sonic weld tooling are selectively changeable depending on which of said plurality of different shaped parts are being processed in said at least one punch and weld station;
at least one position monitoring system adapted to selectively locate a part or at least one part feature of said plurality of different shaped parts; and
at least one programmable robot or machine adapted for processing said plurality of different shaped parts.

20. A flexible assembling system adapted for manufacturing vehicle parts, comprising:
at least one part fixture with universal support adapted for selectively holding a plurality of different shaped parts, wherein the at least one part fixture is not a CNC nest;
at least one punch and weld station, comprising at least one punch tooling and at least one sonic weld tooling, wherein said at least one punch tooling and at least one sonic weld tooling are selectively changeable depending on which of said plurality of different shaped parts are being processed in said at least one punch and weld station;
at least one position monitoring system incorporating artificial intelligence, said at least one position monitoring system adapted to selectively locate a part or at least one part feature of said plurality of different shaped parts at least once each cycle; and
at least one programmable robot or machine adapted for processing said plurality of different shaped parts, wherein once said location is determined, said at least one programmable robot is adapted to selectively retrieve and hold each of said plurality of different shaped parts individually while being processed at said at least one punch and weld station.
